(19) United States
(12) Patent Application Publication
(10) Pub. No.: US 2022/0060092 A1
(43) Pub. Date: Feb. 24, 2022

(54) METHOD FOR PROVIDING SHAPED RODS MADE FROM AN ELECTRICAL CONDUCTOR WIRE AND CORRESPONDING SHAPED RODS

(71) Applicant: Miba eMobility GmbH, Laakirchen (AT)

(72) Inventor: Robert MIESBAUER, Pettenbach (AT)

(73) Assignee: Miba eMobility GmbH, Laakirchen (AT)

(21) Appl. No.: 17/432,116

(22) PCT Filed: Feb. 18, 2020
(86) PCT No.: PCT/AT2020/060048

§ 371 Date: Aug. 19, 2021

(30) Foreign Application Priority Data
Feb. 20, 2019 (AT) A50135/2019

(51) Int. Cl. H02K 15/04; H02K 3/28

(52) U.S. Cl. CPC H02K 15/0428; H02K 3/28

(57) ABSTRACT

The invention relates to a method for provided shaped rods, which are intended for the use in electric windings of electric machines. The invention comprises providing conductor wire (11); positioning the conductor wire (11) and a bending axis (26) for the conductor wire relative to one another, such that the longitudinal axis (18) of the conductor wire (11) and the bending axis (26) run at an oblique angle relative to one another; holding, gripping, or supporting the conductor wire (11) in a first and second section (20, 21) of the conductor wire (11); and carrying out a swivel bending or folding movement (30) between the first and second section (20, 21) of the conductor wire (11) about the bending axis (26). Thereby, a simultaneous forming of a combined torsional and also curved section (17, 19) in the conductor wire (11) and also a lateral offset (16) between the first and second section (20, 21) of the conductor wire (11) is made possible. Moreover, a correspondingly shaped shaped rod is indicated.

The invention relates to a method for providing shaped rods made of an electric conductor wire, shaped rods made from an electric conductor wire, and a stator of an electric machine with such shaped rods, as it is indicated in the claims.

From the prior art, so-called shaped rod windings are known, which are formed of a plurality of shaped rods bent in a defined manner and electrically interconnected. In this regard, a corresponding shaped rod winding is at least partially accommodated in an essentially hollow-cylindrical stator component, which is often configured as a laminated core. These fixed, magnetically effective parts are generally referred to as a stator of an electric machine.

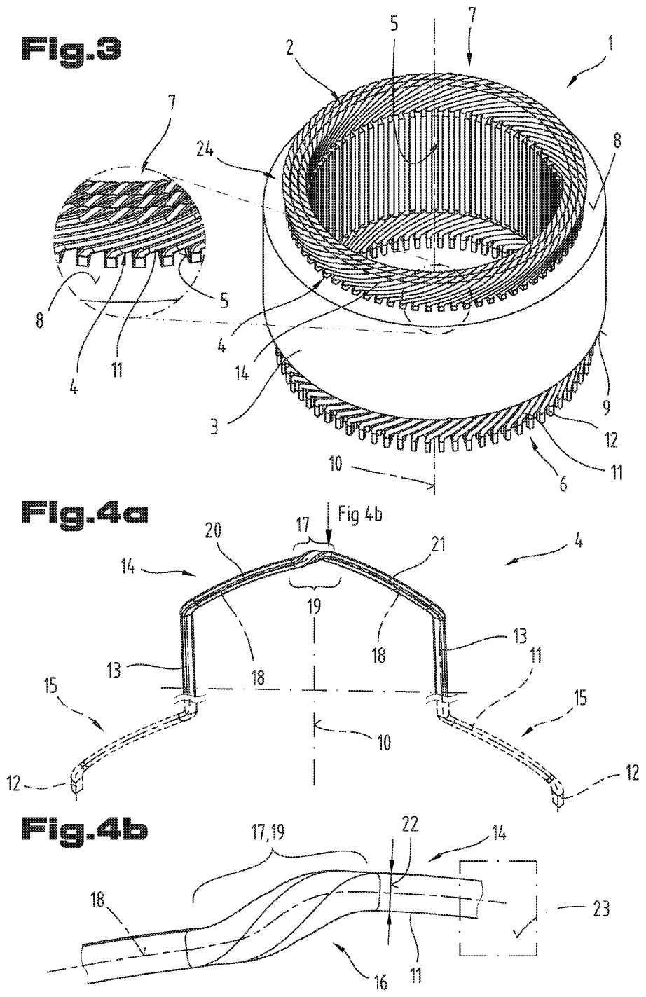

EP2591538B1 describes a method for twisting conductor wires preformed in a clasp shape and correspondingly shaped shaped rods for the use in electric machines. The preformed conductor wires used in this method have a first and a second limb, which originally extend relatively close to each other and which are connected to each other as one piece by an arcuate connection section. In a subsequent deforming step, the first and second limb are pulled apart along two circular paths radially offset from each other by means of disc-type twisting tools arranged coaxially to each other. This creates a shaped rod with limb sections, which are axially parallel and spaced apart comparatively far from each other, and a roof-shaped and/or gable-like connection section connecting said limb sections as one piece, as is shown by way of example in FIGS. 2, 3 of EP2591538B1. The geometry of the shaped rods produced, and the production method used therefor, however, are only satisfactory to a limited extent.

The object of the present invention was to overcome the disadvantages of the prior art and to provide a method, by means of which shaped rods for electric windings can be produced as efficiently as possible and simultaneously in a process-safe manner.

This object is achieved by means of a method and shaped rods produced thereby according to the claims.

The method according to the invention is provided for providing and/or producing shaped rods from an electric conductor wire. In this regard, these shaped rods are to be understood as shaped rod blanks to be processed further and/or as semi-finished products to be processed further. After being processed further, the accordingly provided shaped rods are intended for the use as conductor elements in electric windings, in particular in stator windings of electric machines. Accordingly structured electric windings are also referred to as rod windings. The claimed method comprises following steps:
providing conductor wire, in particular having a polygonal, preferably rectangular, cross-section. In this regard, it is useful if the provided conductor wire runs in a straight line, for example was previously stretched in a straight line. However, it is also possible for individual bends and/or defined angular offsets to already exist in the provided conductor wire. The cross-section of the conductor wire is preferably formed to be rectangular but could also be formed to be square or circular.
positioning and/or orienting the conductor wire and an imaginary and/or notional bending axis for the conductor wire relative to one another, such that the longitudinal axis of the conductor wire and the notional bending axis extend at an oblique angle relative to one another, in particular extend at an angle of 10° to 80° relative to each other, and the longitudinal axis of the conductor wire and the bending axis intersect, so that, with respect to the bending axis, a first and second section of the conductor wire are defined. The bending axis is to be understood as an imaginary and/or virtual axis in this context. In particular, it is not necessary for a structurally formed bending axis to be present. The arrangement at an oblique angle between the longitudinal axis of the conductor wire and the fictitious bending axis is carried out such that orientation angles of 0° and 90° are excluded. It is useful if the provided conductor wire and the bending axis intersect and/or cross each other approximately in the longitudinal center section of the conductor wire.
retaining, gripping, or supporting the conductor wire in its first and in its second section. This temporary retaining and/or fixation of the correspondingly oriented conductor wire may be carried out by mechanical retaining or gripping devices, wherein relative movements between the conductor wire and the retaining or gripping device may also be permitted in the course of the subsequent execution of the bending step. Thus, a rigid clamping of the conductor wire is not necessarily required but these devices may also be formed as retaining bags and/or bending beams, which merely have a pressing function in a defined direction with respect to at least one of the sections of the conductor wire. The retaining or gripping devices may thus be formed such that at least one of the two sections of the conductor wire are not rigidly fixed but has permitted degrees of freedom to allow bending and/or shortening induced compensation movements in the conductor wire. In this regard, the retaining and/or gripping the two partial sections of the conductor wire may be carried out at a radial distance from the virtual bending axis.
carrying out a swivel bending or folding movement between the first and second section of the conductor wire about a swivel angle of 170° to 185°, preferably roughly 180°, about the planned bending axis for simultaneously forming a combined torsional and also curved section in the conductor wire. In the course of the torsion and/or twisting operation with respect to the conductor wire, a lateral offset between the longitudinal axes of the first and second section of the conductor wire is also formed in the torsional and curved section of the conductor wire.

The method according to the claims allows an efficient production of shaped rods and/or shaped rod blanks bent in a defined manner for the use in electric windings. In particular, both the required angulation and/or roof shape in the central yoke section of an essentially U-shaped shaped rod and/or hairpin and a lateral offset between the longitudinal axes of the sections of the conductor wire and/or shaped rod adjoining the torsional and curved section can be achieved in just one work step and/or in just one deforming step. The corresponding fold bending method in combination with a bending axis, which is oriented at an oblique angle relative to the longitudinal axis of the conductor wire, can also be realized with a high process safety. Moreover, the indicated bending method allows achieving a high repeatability with respect to providing shaped rod blanks and/or shaped rods for electric windings.

Furthermore, it may be useful if the bending axis is arranged offset relative to the longitudinal axis of the conductor wire by an extent, which corresponds to approximately half the thickness of the conductor wire, and/or if the bending axis is situated in a plane, which represents a continuation of a flat side of the conductor wire formed to be polygonal in its cross-section, or in parallel to and spaced apart from a flat side of the conductor wire formed to be polygonal in its cross-section. Thereby, a predefined lateral offset can be formed in a simple manner in the yoke section of the shaped rod, by means of which lateral offset a layer jump with respect to the limb sections of the final shaped rod can be realized. Depending on the desired dimension of the lateral offset in the conductor wire, the mentioned spacing and/or its extent may be only a fraction of the thickness of the conductor wire or a multiple of the thickness of the conductor wire. It is further advantageous that this allows keeping the risk of a destruction and/or a strong impairment of the outer insulation layer of the conductor wire to a minimum.

An embodiment according to which the twisting or folding of the conductor wire is carried out inside a partial section, which is less than 20%, in particular less than 10%, preferably between 1% and 5% of the length of the provided electric conductor wire, is also advantageous. Thereby, it is possible to build electric windings having the most compact possible winding head and/or having the shortest possible projection in the axial direction with respect to the axial end face of the stator core.

Furthermore, it may be provided that conductor wires running straight and having a predefined length are provided in the provisioning step, and these electric conductor wires are deformed, in particular folded. Thus, relatively short individual pieces already cut to length can be processed, whereby the process reliability can be improved, and the instrument-based effort can be kept to a minimum.

Moreover, it may be provided that in the swivel bending or folding step, the first or second section of the conductor wire is bent about the bending axis, or the first and second section of the conductor wire are simultaneously bent about the bending axis at least in some phases. On the one hand, as simple a device-technical realization as possible can be achieved thereby. On the other hand, this allows keeping the cycle times for providing corresponding shaped rods as short as possible.

According to an advancement, it is possible that at least one further bend each is produced in the first and second section of the conductor wire for forming an essentially U-shaped shaped rod and/or conductor segment. Especially when these further bending steps are carried out without renewed gripping and/or re-collecting of the shaped rod preformed according to the method, the lowest possible production tolerances and short cycle times can be achieved.

Furthermore, it may be useful if, before the execution of the swivel bending or folding movement, the first and second section of the conductor wire extend axially aligned but at no point extend axially parallel in the course of the production of the torsional and also curved section. Thus, no U-shape of the conductor wire having limbs extending in parallel or approximately in parallel is created beforehand, which limbs are then pulled apart and/or must be spaced apart from one another to create the roof shape and/or the V-shaped section of the hairpin. In contrast to this, an advantageous alternative to creating the roof and/or gable shape of the shaped rod and to creating the lateral offset in the yoke section of the shaped rod is indicated. In this regard, the term “axially parallel” explicitly excludes “axially aligned”.

According to an advantageous measure, it is provided that a plurality of conductor wires positioned in parallel to each other is provided, and these conductor wires are deformed simultaneously. This may favor an efficient production of the shaped rods. In particular it is also easily possible, in combination with the indicated method measures, to form multiple conductor elements, for example five, ten, or even more conductor elements, with high process safety in a common production step. The cycle times for each shaped rod can thereby be kept as short as possible.

Moreover, it is possible for the swivel bending or folding movement to be composed of two folding movements, wherein each of these folding movements is carried out about an angle of approximately 90°, and both folding movements are carried out at longitudinal positions of the conductor wire that are spaced apart from each other. Shaped rods, in which the extent of the lateral offset between the conductor sections can be adapted simply and swiftly to the respective requirements, can be produced thereby. In particular, shaped rods having different degrees of their lateral offset can be produced in an efficient and process-safe manner thereby.

The object of the invention is also achieved by means of a shaped rod formed according to the claims.

Such a shaped rod is preferably made from an electric conductor wire having a polygonal cross-section and constitutes a shaped rod blank and/or a semi-finished product, which is still to be processed further and/or to be additionally shaped, in order to finally be able to serve as a shaped rod for the use in electric windings, in particular to be able to be used in stator windings of electric machines. This shaped rod comprises a torsional section, in which the conductor wire is twisted about an angle of 170° to 185°, preferably of roughly 180°, with respect to its longitudinal axis. In this torsional section, a curved section of the conductor wire and/or shaped rod is also formed, so that first and second sections of the conductor wire, which sections adjoin the curved section, are oriented at an angle relative to each other. Furthermore, a lateral offset between the first and second section of the conductor wire is formed in the combined torsional and curved section of the conductor wire.

Shaped rods with such an integrally designed torsional and also curved section enable the construction of electric windings with as compact and/or as axially short a projection as possible with respect to the axial end face of the stator core. In particular, a short axial construction length of the stator and/or of an electric machine constructed therewith can be achieved thereby. Furthermore, such shaped rods can be produced in an efficient and process-safe manner. Especially the yoke and/or connection section between the limb sections of such a shaped rod can have a high repeatability and/or lie within tight size tolerances. A corresponding shaped rod furthermore enables an adequate layer jump with respect to its two limb sections, meaning the placement of the limb sections in radially different layers of the winding to be produced and thus, a compact and/or space-saving structure of the electric winding.

In particular, it may be useful if, by means of the lateral offset, the longitudinal axes of the first and second section of the conductor wire run offset from each other approximately by the thickness of the conductor wire. This allows achieving a geometrically clearly defined layer jump of one between the limb sections of an essentially U-shaped shaped rod.

According to an advantageous embodiment, it is provided that the conductor wire has a polygonal, in particular a rectangular cross-section. This allows achieving a high filling degree in a stator core with conductor wire with respect to receiving grooves with a rectangular cross-section. Due to the shaping according to the claims of the polygonal conductor wire and/or shaped rod, winding heads being as compact as possible and/or building up as shortly as possible in the axial direction can still be obtained in an electric winding to be built therewith.

The invention also relates to a stator of an electric machine with an electric winding, which is formed of a plurality of shaped rods made from electric conductor wire, wherein at least individual ones of the shaped rods are formed according to the preceding definitions. The technical effects and advantages that can thereby be achieved can be gathered from the above and below parts of the description.

For the purpose of better understanding of the invention, it will be elucidated in more detail by means of the figures below.

These show in a respectively very simplified schematic representation:

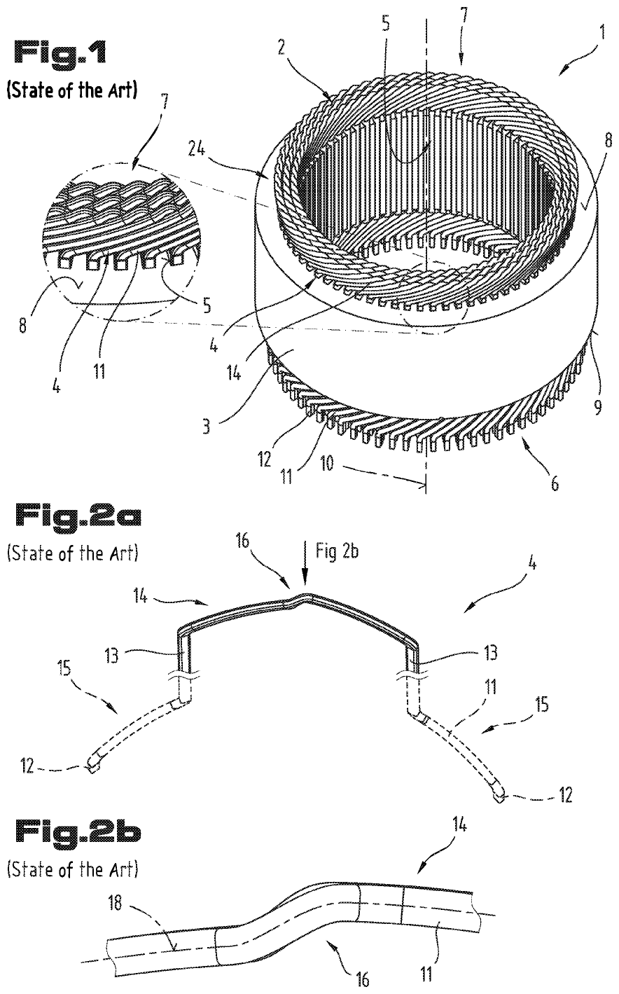

FIG. 1 a stator of an electric machine known from the prior art, in a perspective view;

FIG. 2a a shaped rod made from electric conductor wire as it is used in the electric winding of the stator according to FIG. 1;

FIG. 2b a section of the shaped rod according to FIG. 2a in a top view according to arrow “FIG. 2b” in FIG. 2a;

FIG. 3 a stator formed according to the invention for an electric machine, in a perspective view;

FIG. 4a a shaped rod made from electric conductor wire as it is used in the electric winding of the stator according to FIG. 3;

FIG. 4b a section of the shaped rod according to FIG. 4a in a top view according to arrow “FIG. 4b” in FIG. 4a;

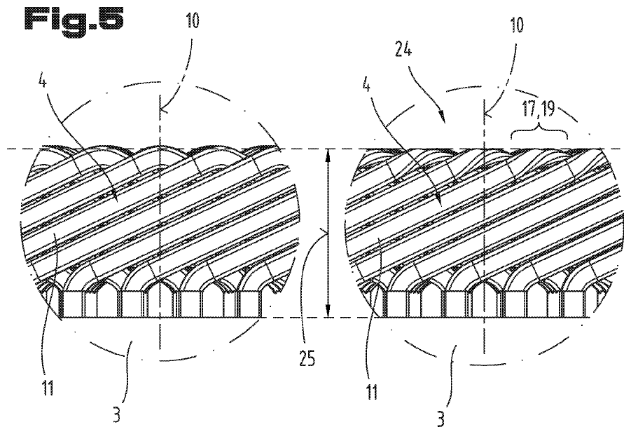

FIG. 5 a comparison of the winding head in the stator according to FIG. 1 and the winding head in the stator according to FIG. 3;

FIG. 6 a representation of the bending pattern and bending method for providing a shaped rod semi-finished product and/or shaped rod blank;

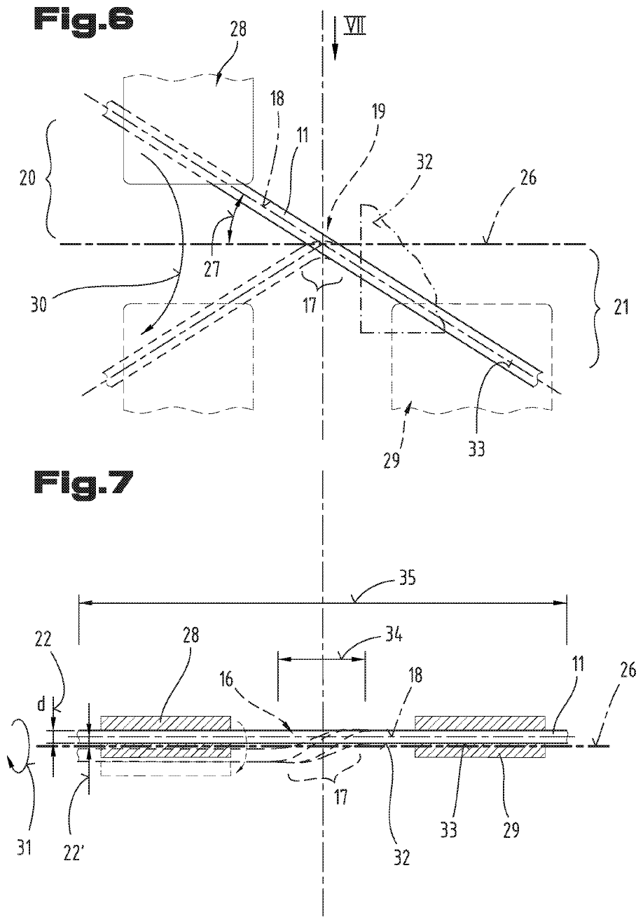

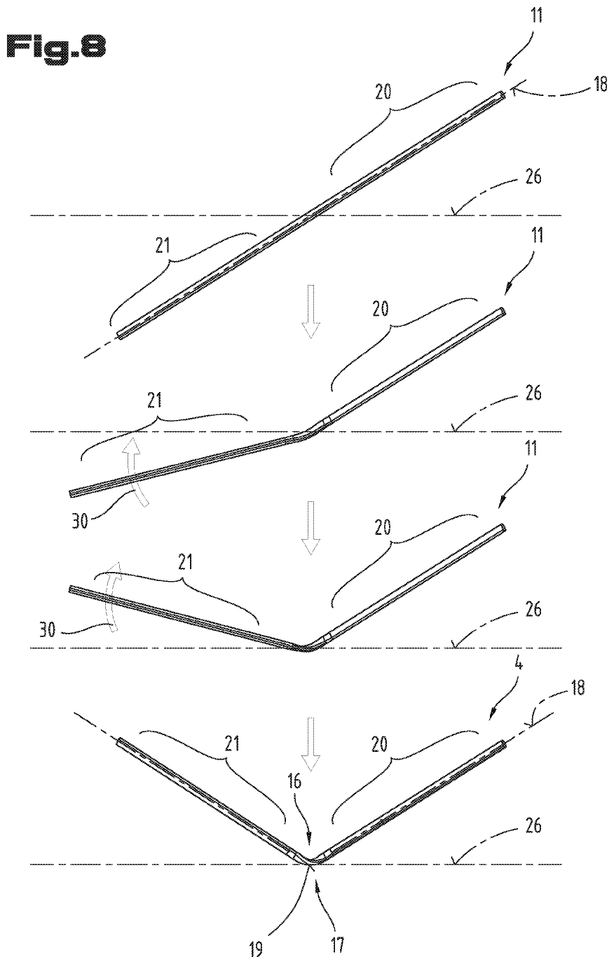

FIG. 7 the bending pattern and bending method according to FIG. 6 in a view according to the arrow “FIG. 6” in FIG. 6;

FIG. 8 the individual phases of an originally straight electric conductor wire, which is deformed according to the indicated method.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

In FIG. 1, a semi-finished product of a stator 1 known from the prior art for an electric machine is illustrated by way of example. This stator 1 has already passed through different stages of production but still has to undergo further stages of production in order to eventually be usable as an operational stator of an electric machine, in particular as a stator of an electric motor.

Such a stator 1 comprises an electric winding 2, which is provided in connection with an approximately annular and/or hollow-cylindrical stator core 3 for generating circumferential magnetic fields, when the winding strands of the winding 2 are subjected to electrical energy, in particular with a single- or multi-phase alternating voltage. The stator core 3 is typically formed as a layered package of individual, stacked sheet metal segments.

In the depicted embodiment, the electric winding 2 is formed as a so-called shaped rod winding in the depicted embodiment, which is occasionally also referred to as rod winding. Here, the electric winding 2 is in particular assembled from a plurality of individual shaped rods 4, wherein such a shaped rod 4 is illustrated by way of example in FIG. 2a and in FIG. 2b. In this regard, such shaped rods 4 are accommodated, at least in some sections, in receiving grooves 5 of the stator core 3. The shaped rods 4 inserted into the stator core 3 are moreover electrically connected to each other and/or interconnected in order to thus form the corresponding electric winding 2 and/or its winding strands. The respectively necessary connection points for applying electrical energy are not shown in FIG. 1 or in FIG. 3 for the sake of clarity.

The winding 2 may be designed as a so-called wave winding in regard to its electrical structure. The shaped rods 4 used have an approximately U-shaped basic shape and are generally also referred to as so-called hairpins. With such shaped rods 4 of the hairpin type, a winding 2 and/or a stator 1 having a contacting and/or welding side 6 and a yoke side 7 opposite thereof, which may also be referred to as hairpin side or as crown side, can be built up. Preferably, the yoke side 7 is designed to be completely free, or at least mostly free, of contacting and/or welding points and assigned nearest to a first axial end face 8 of the stator core 3. In contrast, the contacting and/or welding side 6, on which ends of the individual shaped rods 4 are electrically coupled in a specific manner, is assigned nearest to the second axial end face 9 of the stator core 3 located opposite thereof. A stator central axis 10 runs centrally through the inner cavity of the essentially hollow-cylindrical stator core 3.

The respective shaped rods 4 for forming the electric winding 2 are formed from an electrically conductive conductor wire 11. The conductor wire 11 may be made of copper, of aluminum or of other materials or alloys with good electric conductivity and comprise an electric insulation layer that is known per se on predominant sections of its lateral surface, which insulation layer is typically made of a plastic material. Merely the end sections 12 of the conductor wire 11 intended for contacting and/or welding may be designed to be uninsulated and/or to have been stripped at least in some sections, in order to be able to establish a lowohmic electrical connection with the neighboring and/or adjoining shaped rods 4.

Preferably, the conductor wire 11 is formed to be polygonal, in particular at least approximately rectangular, in regard to its cross-sectional surface. In this regard, the thickness to width ratio of a rectangular conductor wire 11 may be between 1:1.5 and 1:3, preferably around 1:2.

The essentially U-shaped shaped rod 4 shown by way of example in solid lines in FIG. 2a may in particular form a conductor segment in an electric winding 2 to be produced, as it is shown in FIG. 1. In this regard, the shaped rod 4 according to FIG. 2a has been subjected to multiple processing steps, for example bending steps and stripping steps, in order to obtain the depicted embodiment and shaping from an originally straight, in particular stretched, electric conductor wire 11.

After multiple bending steps, such an essentially U-shaped shaped rod 4 is formed such as it is illustrated in FIG. 2a, wherein at least some of the total bending steps required are only carried out after the insertion into the respective receiving grooves 4 of the stator core 3. Particularly the sections of the shaped rod 4, which are assigned nearest to the contacting and/or welding side 6 of the stator core 3, are typically only formed once the previously essentially U-shaped shaped rod 4 has been inserted into the stator core 3 and/or into the respective receiving grooves 5. These sections of the shaped rod 4, which are effectively formed afterwards, have been illustrated in FIG. 2a and in FIG. 4a using dashed lines. A shaped rod 4 formed and/or produced according to the indicated method can thus also be referred to as shaped rod blank.

A generic shaped rod 4 and/or hairpin comprises two limb sections 13 running essentially in parallel to one another, which are provided for being received in receiving grooves 5 of the stator core 3. The two limb sections 13 are connected as one piece to a base and/or yoke section 14 of the shaped rod 3. In particular, two limb sections 13, which run essentially axially parallel to one another starting from the central base and/or yoke section 14, are formed such that the essentially U-shaped basic shape of the shaped rod 4 and/or of the corresponding shaped rod blank is given.

On the end sections of the two limb sections 13 facing away from the base and/or yoke section 14, additional bending sections 15 may be formed, as it is shown by way of example using dashed lines. These additional bending sections 15 may run approximately L- or Z-shaped and are typically formed accordingly only after inserting the U-shaped shaped rod 4 into the stator core 3.

In accordance with the example, a so-called six-layered winding 2 is accommodated in the stator core 3. Accordingly, six limb sections 13 per receiving groove 5, are arranged in a row radially to the stator central axis 10, which limb sections 13 originate from individual shaped rods 4 of the electric winding 2. In this regard, all limb sections 13 located within a uniform radius to the stator central axis 10 can be referred to as winding layer and/or or in short as layer. For the construction of an electric winding 2, it is useful if the limb sections 13 of every shaped rod 4 make layer jumps, meaning they are arranged in different layers of the winding 2 with respect to the radial direction relative to the stator central axis 10. Such a layer jump usually has a jump width of 1, meaning that one of the two limb sections 13 of a shaped rod 4 is arranged offset relative to the other limb section 13 of that shaped rod 4 by exactly one layer. Moreover, the two limb sections 13 of each shaped rod 4 are accommodated in receiving grooves 5 spaced apart from one another with respect to the circumferential direction of the stator core 3. In order to accomplish this in an organized manner, there typically is a lateral offset 16 embodied in the conductor wire 11 in the yoke section 14 of the shaped rod 4. In a top view, such a lateral offset 16 according to the prior art is designed essentially S- or Z-shaped—according to FIG. 2b. Such a lateral offset 16 according to the prior art is either produced by means of positively guided forming tools for the conductor wire 11 or by means of an embossing and/or a die bending method with respect to the conductor wire 11.

Alternatively, such a lateral offset 16 according to the prior art may be formed by conductor sections, which are U-shaped in their initial condition, and which have limb sections positioned close to one another. The limb sections of these U-shaped and/or clasp-shaped conductor sections are subsequently pulled apart in parallel to their midplane. Such twisting tools and methods are known, for example, from the previously mentioned EP2591538B1. In this process, the limbs of originally clasp-shaped conductor loops are spaced apart from one another in order to thus produce shaped rods according to FIGS. 2a, 2b with the S- and/or Z-shaped lateral offset formed in the yoke section 15. However, the shaped rods 4 known from the prior art having an S- and/or Z-shaped lateral offset 16 and their production with the twisting tools required therefor is only satisfactory to a limited extent.

FIGS. 3, 4a and 4b illustrate in a perspective view an example of a stator 1 and/or shaped rod 4 (FIG. 4a, b) embodied according to the invention. For the parts described above, equal reference numbers are used, and the preceding parts of the description may be analogously transferred to equal parts with equal reference numbers.

The shaped rod 4 according to FIG. 4a has a torsional section 17 in its yoke section 14, i.e. in that section which connects, in one piece, the two limb sections 13 running axially parallel. In this torsional section 17, the conductor wire 11 of the shaped rod 4 is twisted about an angle of 170° to 185°, preferably roughly 180°, with respect to the longitudinal axis 18 of the conductor wire 11.

In this regard, a curved section 19 of the conductor wire 11 and/or of the shaped rod 4 is simultaneously embodied within this torsional section 17. In particular, an intersecting and/or an integral torsional and curved section 17, 19 is created in the conductor wire 11, as it is shown by way of example in FIGS. 4a, b.

Accordingly, first and second sections 21, 22 of the conductor wire 11 adjoining the curved section 19 are oriented at an angle relative to each other due to this curved section 19. Moreover, it may be provided that the first and/or second sections 20, 21 per se also have an arcuate curvature, as can be seen in FIG. 4a and also in FIG. 4b. In this regard, the first and/or second section 20, 21 have a greater curvature radius than the curved section 19 positioned in between.

The lateral offset 16 provided and/or implemented by means of the torsional section 17 and located between the first and second section 20, 21 of the conductor wire 11 corresponds approximately to the thickness 22 of the conductor wire. In particular, the torsional section 17 in the conductor wire 11 helps achieve that the longitudinal axes 18 of the first and second section 20, 21 run laterally offset to each other by approximately the thickness 22 of the conductor wire 11. In this regard, this lateral offset 16 refers to a transverse plane 23, which is orthogonally perforated by the stator central axis 10 and/or which transverse plane 23 represents a cross-sectional plane running orthogonally to the two limb sections 13 of the shaped rod 4.

In this regard, the torsional and curved section 17, 19, realized in an integral and/or common manner, of the shaped rod 4 according to the invention has a relatively steady and/or homogeneous curvature progression. In particular the combined torsional and curved section 17, 19 of the improved shaped rod 4, as opposed to a shaped rod 4 according to the prior art (FIG. 2a), has either no or a significantly weaker tapering and/or hump-type elevation in its center section. A comparatively distinctive tapering and/or hump-type elevation occurs in the center section of the shaped rods 4 according to FIG. 2a when they are formed from an initially U-shaped conductor loop, whose limbs originally run relatively close to each other and which limbs were subsequently spaced apart from one another, as can also been seen in FIGS. 2, 3 of the previously mentioned EP2591538B1.

A shaped rod 4 embodied according to the invention with an integrally formed torsional and curved section 17, 19-FIG. 4a and FIG. 4b—enables the formation of a winding head 24 of a stator winding, which winding head 24 has a lower axial height 25 (right image in FIG. 5) than a winding head with shaped rods 4 according to the prior art (left image in FIG. 5). By means of the embodiment according to the invention, the axial construction length of the stator 1 and/or an electric motor constructed therewith can be kept comparatively short. Moreover, an economization of conductor wire 11 and optimizations with regard to weight and material cost can be achieved thereby.

The curved section 19 and also the lateral offset 16 in the yoke section 14 and/or in the center section (the so-called roof and/or gable region) of the shaped rod 4 according to the invention—FIG. 4a—is, in this regard, formed in the course of the formation of the torsional section 17, so that no separate bending step has to be performed in order to form the curved section 19 and also the lateral offset 16 in the yoke section 14 and/or in the center section of the shaped rod 4.

A production method, which makes the optimized production of a corresponding shaped rod 4 possible, is explained below:

In this regard, the corresponding production method for the shaped rod 4 is to be understood only as a partial process. In particular, such a shaped rod 4 is to be processed further and/or to be subjected to further production steps, and the shaped rod 4 produced by means of the indicated method represents merely a shaped rod blank and/or a semi-finished product. The corresponding shaped rod blank 4 is made from an electric conductor wire 11 in this regard. Such a shaped rod 4 is suitable for the use as a conductor element in an electric winding, in particular in a stator winding of an electric machine, only after further processing has been concluded.

In the course of this provisioning method, a preferably straight and/or elongated conductor wire 11 with a preferably polygonal, in particular rectangular, cross-section is provided.

This conductor wire 11 is positioned relative to a bending axis 26, as is illustrated schematically and by way of example in FIG. 6. In this regard, this bending axis 26 can be understood to mean a virtual and/or imagined bending axis. The positioning and/or orientation of the conductor wire 11 relative to the bending axis 26 is carried out such that the longitudinal axis 18 of the straight conductor wire 11 and the bending axis 26 extend at an angle 27 relative to each other. In this process, the conductor wire 11 is in particular arranged and/or oriented at an oblique angle relative to the bending axis 26. The angle 27 between the longitudinal axis 11 and the bending axis 26 may be between 10° and 80°, however not 0° and 90°. The bending edge that is planned and/or to be produced in the conductor wire 11 thus extends at an oblique angle to the longitudinal axis 18 of the conductor wire 11. The extent of the angle 27 is a determining factor here for the desired “roof angle” and/or enclosing angle between the sections 20 and 21 of the shaped rod 4 to be produced. However, the respectively selected angle 27 can also be a determining factor and/or a co-determining factor for the distance and/or pitch between the two limb sections 13 of a shaped rod 4 to be produced.

The positioning and/or arrangement between the conductor wire 11 and of the bending axis 26 is further carried out such that the longitudinal axis 18 of the conductor wire 11 and the bending axis 26 intersect, in particular approximately with respect to the longitudinal center section of the conductor wire 11, as it was illustrated by way of example in FIG. 6. Accordingly, a first and a second section 20, 21 of the conductor wire 11 to be processed and/or deformed is defined by this positioning and/or orientation step with respect to the virtual bending axis 26.

After the corresponding positioning and/or orientation, the conductor wire 11 is preferably held and/or gripped or at least supported in its first and in its second section 20, 21. For this purpose, a holding or gripping device 28, 29 shown schematically in FIG. 6 may be provided. The corresponding holding, gripping, or supporting tool for the sections 20, 21 of the conductor wire 11 may, in this regard, be arranged—as shown—at a radial distance from the bending axis 26, or at least partially extend to the bending axis 26 or close to the bending axis 26. Such holding, gripping, or supporting tools may comprise finger- and/or fork-like elements, which allow defined relative movements of the conductor wire relative to the mentioned tool in the course of the deforming operation of the conductor wire 11.

After such a holding, gripping, or supporting operation with respect to an accordingly oriented conductor wire 11, a swivel bending or folding movement 30 is carried out between the first and second section 20, 21 of the conductor wire 11. In this process, the conductor wire 11 is folded, in particular warped and/or twisted, in the vicinity of the virtual bending axis 26. The swivel angle 31—FIG. 7 —, which is embodied between the two sections 20, 21 of the conductor wire 11 and/or realized with respect to the bending axis 26 by means of the holding or gripping device 28, 29, is between 170° and 185°, preferably roughly 180°. The swivel bending or folding movement 30 about the bending axis 26 enables a simultaneous and/or common formation of a combined torsional and also curved section 17, 19 in the conductor wire 11. In particular, the torsional section 17 and the lateral offset 16 in the conductor wire 11 is created thereby in addition to the creation of the curved section 19 with the first and second section 20, 21 running at an angle relative to one another. Accordingly, an integral torsional and also curved section 17, 19 in the conductor wire 11 is created by means of the indicated measures, and in this process, the lateral offset 16 between the first and second section 20, 21 of the conductor wire 11 is also formed, as can be seen in a combination of FIGS. 6, 7 and also FIG. 8.

Thus, by means of the indicated measures, the so-called roof and/or gable shape of the shaped rod 4, in particular its first and second sections 20, 21 running at an angle relative to one another, can be created in just one processing step, and simultaneously, the lateral offset 16 in the conductor wire 11 can be realized. This is achieved in particular by means of the orientation and/or positioning of the conductor wire 11 at an oblique angle relative to the bending axis 26 and by means of the swivel bending or folding movement 30 relative to this bending axis 26. Ultimately, the integrally and/or simultaneously formed torsional and also curved section 17, 19 along with the lateral offset 16 in the conductor wire 11, in particular in the center section of the yoke section 14, is efficiently created by means of these method measures. The so-called roof and/or gable shape and the lateral offset 16 in the region of the yoke section 14 of the shaped rod 4 can thus be formed economically and also in a process-safe manner.

It may be useful if, in the course of this deforming operation for the conductor wire 11, the factually imaginary bending axis 26 is arranged offset relative to the longitudinal axis 18 of the conductor wire 11 by approximately half the thickness 22 of the conductor wire 11. In particular, it is useful if the bending axis 26 is situated in a plane 32, which represents the continuance of one of the two flat sides 33 of the conductor wire 11, or which plane 32 runs in parallel and closely spaced apart from one of the two flat sides 33 of the conductor wire 11 having a preferably rectangular cross-section. This creates the lateral offset 16 in the conductor wire 11 without an increased risk of damage to the plastic insulation layer on the lateral surface of the conductor wire 11.

In this process, the twisting and/or folding of the conductor wire 11 is carried out within a partial section 34 of the conductor wire 11, which is less than 20%, in particular less than 10%, of a length 35 of the provided electric conductor wire 11. The partial section 34, however, may also be only 1% to 5% of the length 35 of the conductor wire 11 without causing damage to the insulation layer of the conductor wire 11. Accordingly, the integral torsional and curved section 17, 19 is designed to be relatively short and/or compact with respect to the length 35 of the conductor wire 11.

It is useful if conductor wire pieces already cut to length and/or having a defined length 35 are deformed. In particular, it is useful if, in the course of the provisioning step, straight and/or elongated electric conductor wires of a predefined length 35 are provided, and these electric conductor wires 11 are twisted and/or folded according to the method, approximately in their longitudinal center section.

In the embodiment of the swivel bending or folding movement 30 according to the method, it is possible, on one hand, that the first or second section 20, 21 of the conductor wire 11 is bent about the bending axis 26. As an alternative, it is also possible that the first and also the second section 20, 21 of the conductor wire are bent simultaneously about the virtual bending axis 26 at least in some phases. This essentially depends on how much space is available and/or how the holding or gripping devices 28, 29 are designed.

The images according to FIGS. 6, 7 and also the bending sequences in the course of the swivel bending or folding movement 30 shown in FIG. 8 illustrate the creation of the integrated and/or combined torsional and also curved section 17, 19 in the conductor wire 11. In addition, it is necessary for the creation of a shaped rod 4 according to FIG. 4a, 4b that, in both the first and second section 20, 21, at least one further bend for forming an essentially U-shaped conductor segment and/or shaped rod 4 is produced. Moreover, further bending operations may also be carried out following the swivel bending or folding step illustrated in FIGS. 6, 7, as can be seen in FIGS. 4a, 4b. However, individual bending operations for the shaped rod 4 to be produced may also have been carried out prior to the indicated swivel bending or folding movement 30. Thus, conductor wires 11 preformed in a Z- or L-shape, which define the bending sections 15 (FIG. 4a), or conductor wires 11 preformed in a different way may also be subjected to the provisioning method according to the claims.

As can be seen from a combination of FIGS. 6, 7 and also from the bending and/or deforming process according to FIG. 8, the first and second section 20, 21 of the conductor wire 11 at no point in time run axially parallel to one another in the context of the production of the torsional and also curved section 17, 19. In particular, it is not required to create a U-shape and/or a clasp shape, which has limbs running in parallel to one another and being arranged at a close distance from each other, in advance, which limbs then have to be pulled apart in order to create the roof shape and/or the V-shaped section of a hairpin.

In particular by twisting and/or warping the conductor wire 11 about a bending axis 26 that is inclined and/or runs in an inclined manner, which moreover is offset by slightly more than half the thickness 22 of the conductor wire 11, the desired roof shape as well as the lateral off-set 16 in the longitudinal center section and/or yoke section 14 of the conductor wire 11 is created in just one work step.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 Stator
2 Winding
3 Stator core
4 Shaped rod
5 Receiving groove
6 Contacting and/or welding side
7 Yoke side
8 Axial end face
9 Axial end face
10 Stator central axis
11 Conductor wire
12 End sections
13 Limb sections
14 Yoke section
15 Bending sections
16 Offset
17 Torsional section
18 Longitudinal axis
19 Curved section
20 First section
21 Second section
22 Thickness
23 Transverse plane
24 Winding head
25 Axial height
26 Bending axis
27 Angle
28 Retaining or gripping device
29 Retaining or gripping device
30 Swivel bending or folding movement
31 Swivel angle
32 Plane
33 Flat side
34 Partial section
35 Length

1. A method for providing shaped rods (4) in the form of shaped rod blanks still to be processed further made from an electric conductor wire (11), which shaped rods (4) are intended for the use in electric windings (2) of electric machines, in particular in stator windings, comprising the steps:
providing conductor wire (11);
positioning the conductor wire (11) and a bending axis (26) for the conductor wire relative to one another, such that the longitudinal axis (18) of the conductor wire (11) and the bending axis (26) run at an oblique angle relative to one another, in particular at an angle (27) between 10° and 80°, and the longitudinal axis (18) of the conductor wire (11) and the bending axis (26) intersect, so that a first and second section (20, 21) of the conductor wire (11) are defined with regard to the bending axis (26);
holding, gripping, or supporting the conductor wire (11) in its first and in its second section (20, 21);
carrying out a swivel bending or folding movement (30) between the first and second section (20, 21) of the conductor wire (11), about a swivel angle (31) of 170° to 185°, preferably roughly 180°, about the bending axis (26) for simultaneously forming a combined torsional and also curved section (17, 19) in the conductor wire (11) and also a lateral off-set (16) between the first and second section (20, 21) of the conductor wire (11).

2. The method according to claim 1, wherein the bending axis (26) is arranged offset relative to the longitudinal axis (18) of the conductor wire (11) by an extent (22′), which corresponds to approximately half the thickness (22) of the conductor wire (11), or is situated in a plane (32), which represents a continuation of a flat side (33) of the conductor wire (11) formed to be polygonal in its cross-section, or in parallel to and spaced apart from a flat side (33) of the conductor wire (11) formed to be polygonal in its cross-section.

3. The method according to claim 1, comprising twisting or folding the conductor wire (11) within a partial section (34), which is less than 20%, in particular less than 10%, of the length (35) of the conductor wire (11).

4. The method according to claim 1, wherein, in the provisioning step, straight conductor wires (11) of a predefined length (35) are provided, and these conductor wires (11) are deformed in their longitudinal center section in the course of the execution of the swivel bending or folding movement (30).

5. The method according to claim 1, wherein, in the swivel bending or folding step (30), the first or second section (20, 21) of the conductor wire (11) is bent about the bending axis (26), or the first and second section (20, 21) of the conductor wire (11) are simultaneously bent about the bending axis (26) at least in some phases.

6. The method according to claim 1, wherein at least one further bend each is produced in the first and second section (20, 21) of the conductor wire (11) for forming an essentially U-shaped shaped rod (4).

7. The method according to claim 1, wherein, before the execution of the swivel bending or folding movement (30), the first and second section (20, 21) of the conductor wire (11) extend axially aligned but at no point extend axially parallel in the course of the production of the torsional and also curved section (17, 19).

8. The method according to claim 1, wherein a plurality of conductor wires (11) positioned in parallel to one another is provided, and these conductor wires (11) are deformed simultaneously by the execution of the swivel bending or folding movement (30).

9. The method according to claim 1, wherein the swivel bending or folding movement (30) is composed of two folding movements, wherein each of these folding movements is carried out about an angle of approximately 90°, and both folding movements are carried out at longitudinal positions of the conductor wire (11) that are spaced apart from each other.

10. A shaped rod (4) in the form of a shaped rod blank still to be processed further made from an electric conductor wire (11), which shaped rod (4) is intended for the use in electric windings (2) of electric machines, in particular in stator windings, produced according to the method of claim 1, wherein the shaped rod (4) comprises a torsional section (17), in which the conductor wire (11) is twisted by an angle of 170° to 185°, preferably roughly 180°, with respect to its longitudinal axis (18), and in which torsional section (17), moreover, a curved section (19) of the conductor wire (11) is formed, so that first and second sections (20, 21) of the conductor wire (11) adjoining this combined torsional and curved section (17, 19) are oriented at an angle relative to one another, and a lateral offset (16) between the first and second section (20, 21) of the conductor wire (11) is also formed in the combined torsional and curved section (17, 19) of the conductor wire (11).

11. The shaped rod according to claim 10, wherein by means of the lateral offset (16), the longitudinal axes (18) of the first and second section (20, 21) of the conductor wire (11) run offset from each other approximately by the thickness (22) of the conductor wire (11).

12. The shaped rod according to claim 10, wherein the conductor wire (11) has a polygonal, in particular a rectangular, cross-section.

13. A stator (1) of an electric machine, with an electric winding (2), which is formed of a plurality of shaped rods (4) made from conductor wire (11), wherein at least individual ones of the shaped rods (4) are designed according to claim 10.
